(19) United States
(12) Patent Application Publication
(10) Pub. No.: US 2007/0134081 A1
(43) Pub. Date: Jun. 14, 2007

(54) Tool carrier attachment adapter

(76) Inventor: Steven Paul Seabolt, Perry, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(21) Appl. No.: 11/134,024

(22) Filed: May 20, 2005

Related U.S. Application Data
(60) Provisional application No. 60/573,511, filed on May 21, 2004.

(51) Int. Cl. B66C 23/00

(52) U.S. Cl. 414/723

(57) ABSTRACT

A work machine having a work tool used in excavation and earth moving operations. In a preferred embodiment the work machine has boom pivotally connected to the frame of the machine. A dipperstick is pivotally connected to the end of the boom and adapted to support a cylinder assembly thereon. A tool carrier attachment adapter is connected to both the distal end of the dipperstick and to the cylinder assembly. The tool carrier attachment adapter has a mounting bracket and an attachment coupling. The mounting bracket pivotally connects the attachment adapter to the dipper stick and cylinder assembly and supports the attachment coupling. The attachment coupling comprises a planar member adapted to engage the work tool.

### CROSS REFERENCE TO RELATED APPLICATIONS

This application claims the benefit of U.S. Provisional Application No. 60/573,511 filed May 21, 2004, the contents of which are incorporated fully herein by reference.

### FIELD OF THE INVENTION

The present invention relates generally to the field of work machines generally used in construction operations, and in particular to excavators adapted to support a wide variety of work tools for use thereon.

### SUMMARY OF THE INVENTION

The present invention is directed to a work machine. The work machine comprises a frame, a dipperstick, a cylinder assembly and a tool carrier attachment adapter. The dipperstick supported by the frame and the cylinder assembly is supported by the dipperstick. The tool carrier attachment adapter comprises a mounting bracket, a pin boss mounting assembly, and an attachment coupling. The pin boss mounting assembly is supported by the mounting bracket and adapted to operatively connect the mounting bracket to both the dipperstick and the hydraulic cylinder. The attachment coupling comprises a planar member connected to the mounting bracket and comprises a planar face adapted to engage a work tool. The cylinder assembly is adapted to move the tool carrier attachment adapter.

The present invention is further directed to a tool carrier attachment adapter for use with a work machine. The work machine comprises a dipperstick and a cylinder assembly supported by the dipperstick. The tool carrier attachment adapter comprises a pin boss mounting assembly and an attachment coupling connected to the pin boss mounting assembly. The attachment coupling comprises a planar member having a planar face adapted to engage a work tool. The pin boss mounting assembly operatively connects the attachment adapter to both the dipperstick and the hydraulic cylinder.

Further still, the present invention includes a work machine. The work machine comprises a frame, a dipperstick supported on the frame, a cylinder assembly connected to the dipperstick, and a tool carrier attachment adapter. The tool carrier attachment adapter comprises a pin boss mounting assembly and an attachment coupling. The pin boss mounting assembly operatively connects the attachment adapter to both the dipperstick and the hydraulic cylinder. The attachment coupling comprises a planar member connected to the pin boss mounting assembly and has a planar face adapted to engage a work tool. The cylinder assembly is adapted to move the tool carrier attachment adapter.

The present invention further includes a work machine comprising a frame, a dipperstick supported on the frame, a cylinder assembly connected to the dipperstick, a bucket quick coupler operatively connected to both the dipperstick and the cylinder, and a tool carrier attachment adapter. The bucket quick coupler comprises a saddle. The tool carrier attachment adapter comprises a mounting bracket having at least one plate configured to matingly engage the saddle of the bucket quick coupler, an attachment coupling, and a latching assembly. The attachment coupling is connected to the mounting bracket and adapted to engage a work tool. The latching assembly is supported by the mounting bracket to fasten the work tool to the attachment coupling.

### BRIEF DESCRIPTION OF THE DRAWINGS

FIG. 1 is a side elevational view of a work machine of the present invention. The work machine illustrated in FIG. 1 is an excavator having a work tool comprising a trenching assembly supported on a tool carrier attachment adapter. The tool carrier attachment adapter is operatively connected to the dipperstick and cylinder assembly of the excavator.

FIG. 2 is a perspective view of the tool carrier attachment adapter of FIG. 1. FIG. 2 illustrates construction of a preferred tool carrier attachment adapter of the present invention connectable to the dipperstick and cylinder assembly of the excavator.

FIG. 3 is a perspective view of an alternative embodiment of the tool carrier attachment adapter of the present invention. In the embodiment of FIG. 3 the attachment coupling is movable relative to a mounting bracket.

FIG. 4 is a perspective view of the tool carrier attachment adapter of FIG. 3 illustrating the use of an actuator assembly to drive movement of the attachment coupling relative to the mounting bracket.

FIG. 5 is a perspective view of an alternative tool carrier attachment adapter of the present invention. The tool carrier attachment adapter of FIG. 5 shows an attachment adapter mountable to a bucket quick coupling system.

FIG. 6 is a diagrammatic representation of the tool carrier attachment adapter of the present invention and a work tool configured for attachment to the attachment adapter of the present invention.

### DESCRIPTION

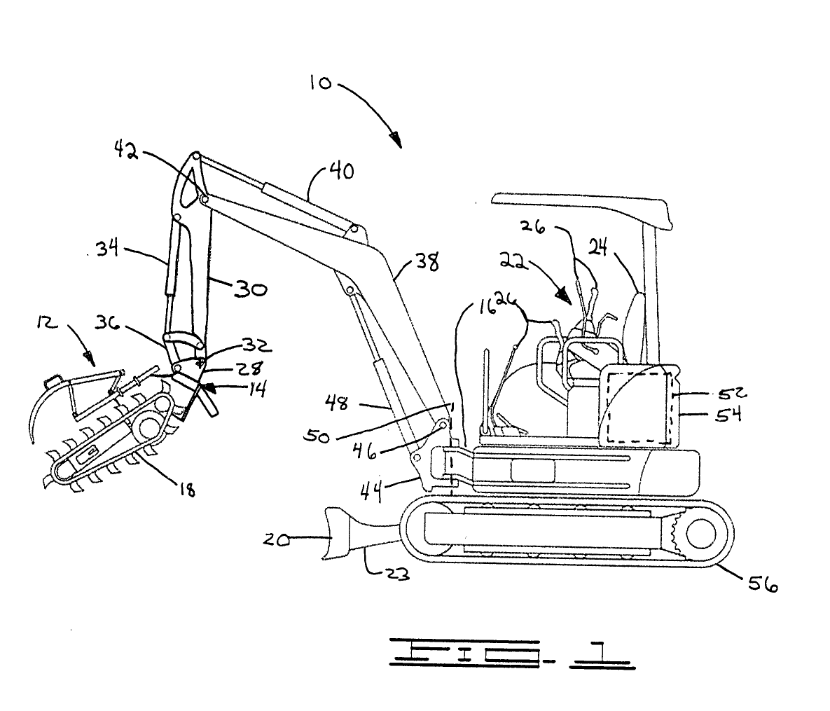

Turning now to the figures and first to FIG. 1, there is shown therein a work machine 10 of the present invention. The work machine 10 shown in FIG. 1 is an excavator that, among other things, may be used to dig trenches and move earth. The excavator 10 shown in FIG. 1 may be generally characterized as a “mini-excavator” having hydraulic power for operation of hydraulically operated work tools such as a trenching assembly 12. The excavator 10 is also equipped with a tool carrier attachment adapter 14 that allows the operator to quickly change tools when necessary.

The work machine 10 illustrated in FIG. 1 comprises a frame 16 capable of supporting a first work tool 18, a second work tool 20 and an operator station 22 thereon. For purposes of illustration only, the first work tool 18 shown in FIG. 1 is the trenching assembly 12 connected to the tool carrier attachment adapter 14 of the present invention. It will be appreciated that a wide variety of work tools used in excavation and earth moving operations may be supported on the attachment adapter 14 without departing from the spirit of the invention. The second work tool 20 shown in FIG. 1 comprises a backfill blade supported on lift arms 23. The operator station 22 comprises an operator seat 24 and a plurality of controls 26 which allow the operator to control movement of the work machine 10 as well as operation of the first work tool 18 and the second work tool 20.

The attachment adapter 14 comprises a mounting bracket 28 adapted to operatively connect the attachment adapter to a dipperstick 30 so that the attachment adapter 14 is pivotal about a first pivot axis 32. A cylinder assembly 34 is used to pivot the attachment adapter 14 about axis 32. The cylinder assembly 34 is supported by the dipperstick 30 and may be connected to the mounting bracket 28 of the attachment adapter 14 using a four-bar linkage 36.

The dipperstick 30 is pivotally connected to a boom 38. A dipperstick cylinder assembly 40 is supported on the boom 38 and used to move the dipperstick 30 about a pivot point 42 defined by the connection between the boom and the dipperstick. The boom 38 is operatively connected to a swing post 44 and movable about pivot point 46 in response to actuation of a boom cylinder 48. The swing post 44 is pivotal on a vertical axis 50 defined by the connection between the frame 16 of the work machine 10 and the swing post and in response to actuation of a swing post cylinder (not shown).

Continuing with FIG. 1, the work machine 10 further may comprise a power source 52 supported by the frame 16 and within an engine compartment 54. The power source 52 may comprise an internal combustion engine. It will be appreciated, of course, that different type engines or power sources may be used to power the work machine 10. The power source 52 is adapted to drive operation of a drive system 56, and the various hydraulic and electrical systems used with the work machine 10. The drive system 56 is supported by the frame 16 for propelling the work machine 10 in a plurality of directions. It will be appreciated that the engine compartment 54 and operator station 22 are rotatable about a vertical axis (not shown) relative to the drive system 56. The drive system 56 shown in FIG. 1 comprises an all-terrain endless track system. However, it will be appreciated that the drive system 56 may comprise a plurality of low-profile wheels that are capable of being steered in a skid, articulated, coordinated or conventional arrangement without departing from the spirit of the invention.

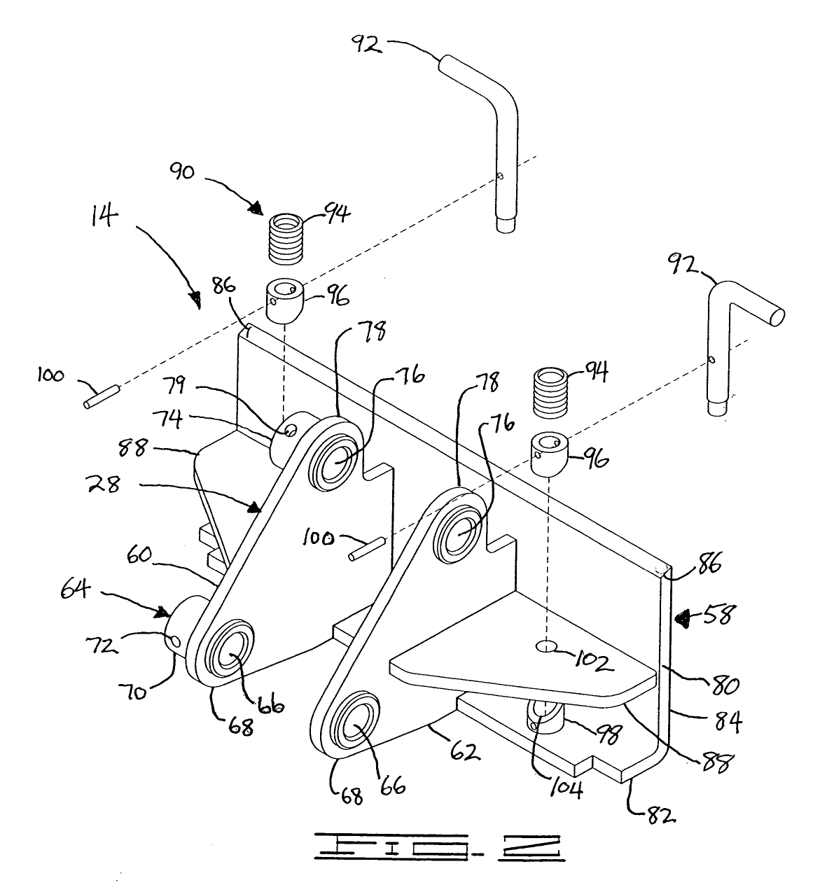

Turning now to FIG. 2, there is shown therein the tool carrier attachment adapter 14 of the present invention. The tool carrier attachment adapter 14 comprises the mounting bracket 28 and an attachment coupling 58 connected to the mounting bracket. The mounting bracket 28 may comprise a first plate 60 and a second plate 62. The first plate 60 and the second plate 62 may be formed from any material capable of withstanding the forces applied to the mounting bracket 28 during excavation operations. The first plate 60 and the second plate 62 may be fixed to the attachment coupling 58 in a generally parallel arrangement. The first plate 60 and second plate 62 of the mounting bracket 28 support a pin boss mounting assembly 64. The pin boss mounting assembly 64 is adapted to operatively connect the mounting bracket 28 to both the dipperstick 30 (FIG. 1) and the cylinder assembly 34.

The pin boss mounting assembly 64 comprises axially aligned circular apertures 66 positioned near the bottom 68 of plates 60 and 62. Pivot boss 70 is axially aligned with the circular apertures 66 and secured to the outer surfaces of the first plate 60. A pivot pin (not shown) is insertable into apertures 66 and pivot boss 70. A retaining pin (not shown) may be inserted into aperture 72 to secure the pivot pin within pivot boss 70.

In operation, the end of the dipperstick 30 is connected to the mounting bracket 28 by positioning the dipperstick between the first plate 60 and the second plate 62 so that apertures (not shown) formed in the dipperstick are axially aligned with pivot boss 70 and apertures 66. A pivot pin (not shown) is inserted through the aligned apertures. The retaining pin is inserted into the aperture 72 to secure the pivot pin within the apertures 66.

Pivot boss 74 is affixed to the outside of the first plate 60 in axial alignment with apertures 76 formed near the top 78 of the first plate 60 and the second plate 62. A pivot pin (not shown) is inserted through the pivot boss 74, apertures 76 and the apertures (not shown) formed in the linkage assembly 36 to connect the cylinder assembly 34 to the mounting bracket 28. A retaining pin (not shown) may be inserted into aperture 79 and the pivot pin to secure the pivot pin within the apertures 76 and the pivot boss 74.

Continuing with FIG. 2, the tool carrier attachment adapter 14 comprises the attachment coupling 58. The attachment coupling 58 comprises a first planar member 80 and a second planar member 82 perpendicular thereto, both rigidly attached to the mounting bracket 28. As shown in FIG. 2, the first planar member 80 and second planar member 82 may be integrally formed. The first planar member 80 has a planar face 84 and rounded edge 86 adapted to engage the work tool 18.

Support brackets 88 may be affixed to the outer surface of the first plate 60, the second plate 62 and the attachment coupling 58 to provide the attachment adapter 14 increased rigidity.

Referring still to FIG. 2, the attachment adapter 14 further comprises a latching assembly 90 adapted to fasten the work tool 18 to attachment coupling 58. The latching assembly 90 comprises L-shaped latch pins 92, a compression spring 94, a first ramp 96, a second ramp 98 and retaining pins 100. The latch pins 92 are insertable through springs 94 and secured to the first ramp 96 using retaining pins 100. The compression springs 94 are disposed between the support brackets 88 and the top of the first ramp 96. The first ramp 96 has a sloped underside that is adapted to engage the sloped top side of the second ramp 98.

The latch pins 92 are inserted through apertures 102 formed in the support brackets 88 and secured to the first ramps 96 using retaining pins 100. Compression springs 94 bias the first ramps 96 toward the second ramps 98. Second ramps 98 are affixed to the second planar member 82 and comprise apertures 104 through which the latch pins 92 are inserted.

In operation, the springs 94 bias the latch pins 92 and first ramps 96 toward the second ramps 98. In the latched position, the latch pins 92 and first ramps 96 secured thereto are rotated so that the sloped edge of the first ramps 96 matingly engages the correspondingly sloped edge of the second ramps 98. When the latch pins 92 are rotated outward, as shown in FIG. 2, the sloped edges of the first ramps 96 and the second ramps 98 are disengaged and forced apart. This action causes the latch pins 92 to move upward and out of a corresponding apertures (not shown) in the work tool 18. Moving the latch pins 92 in this manner unlatches the work tool 18 and allows for removal of the work tool from the attachment adapter 14.

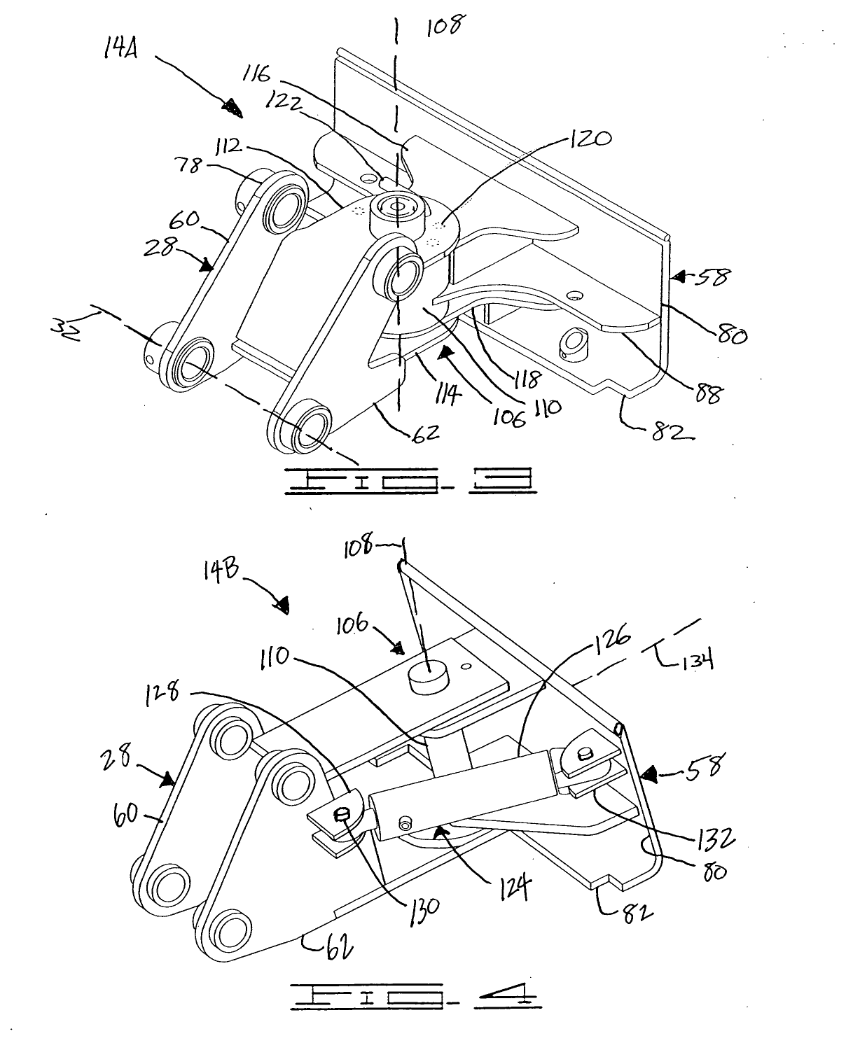

Turning now to FIG. 3, there is shown therein an alternative embodiment of the tool carrier attachment adapter of FIG. 2. The tool carrier attachment adapter 14A of FIG. 3 comprises a rotation plate assembly 106 supported by the mounting bracket 28. The rotation plate assembly 106 defines a pivot axis 108 about which the attachment coupling 58 is movable relative to the mounting bracket 28.

The rotation plate assembly 106 comprises a commonly used pivot joint 110 supported on the attachment coupling 58 and disposed between a first extension member 112 and a second extension member 114. The pivot joint 110 is connected to the attachment coupling 58 by a first pivot joint bracket 116 and a second pivot joint bracket 118. The brackets 116 and 118 are secured to the support brackets 88. The first extension member 112 is supported between the top 78 of the first plate 60 and the top 78 of the second plate 62 of the mounting bracket 28.

First pivot joint bracket 116 may comprise a plurality of apertures 120 adapted for fixing the attachment coupling 58 in a desired orientation relative to the mounting bracket 28. A pin 122 is inserted through an aperture in first extension member 112 and apertures 120 to lock the attachment coupling 58 in the desired orientation. As shown in FIG. 3, the attachment coupling 58 may be pinned in at least five different position orientations; straight ahead, 45 degrees to either side of straight ahead and 90 degrees to either side.

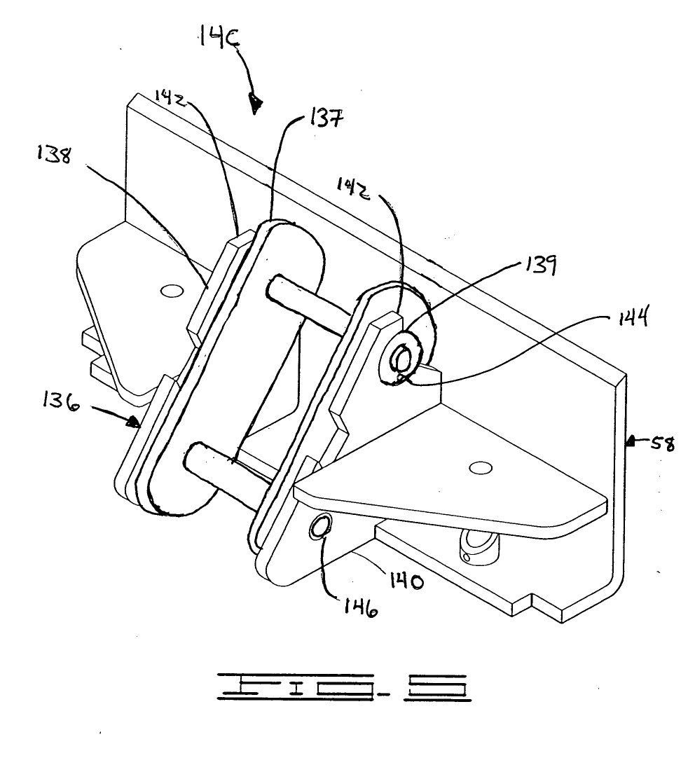

Turning now to FIG. 4, there is shown therein an alternative embodiment of the tool carrier attachment adapter 14A shown in FIG. 3. The tool carrier attachment adapter 14B of FIG. 4 comprises an actuator assembly 124 connectable between the mounting bracket 28 and the first planar member 80 of the attachment coupling 58. The actuator assembly 124 is adapted to move the planar member 80 about the pivot axis 108 defined by the pivot joint 110 of the rotation plate assembly 106.

The actuator assembly 124 may comprise a hydraulic cylinder 126 connected at one end to a cylinder bracket 128 using a retaining pin 130. The cylinder bracket 128 is supported on the second plate 62 of the mounting bracket 28. However, it will be appreciated that the cylinder bracket 128 may alternatively be supported on the first plate 60. The opposite end of the hydraulic cylinder 126 is connected to a cylinder bracket 132 supported on the first planar member 80. It will also be appreciated that in addition to driving pivotal movement of the attachment coupling 58, the hydraulic cylinder 126 may be used to fix the first planar member 80 in a desired pivotal orientation relative to the mounting bracket 28.

It will be appreciated that the above described manual system and hydraulic system may be adapted so that the attachment coupling 58 is also tiltable about a longitudinal axis 134. Tilting of attachment coupling 58 may be accomplished with a commonly known pivot joint actuated by a hydraulic cylinder (not shown). For example, the pivot joint may comprise a pair of plates disposed perpendicular to the longitudinal axis 134; wherein one of the plates is rotatable relative to the other by a hydraulic cylinder connected to rotatable plate at one end and the mounting bracket 28 at the other end. Tilting the attachment coupling 58 about axis 134 allows the operator to maintain a desired orientation of the work tool 18 with respect to the ground as the excavator 10 functions and maneuvers. For example, tilting of the attachment coupling 58 about axis 134 and pivoting about axis 108 allows for efficient trenching on the opposite side of a fence or guard rail from where the excavator 10 is located and parallel with the direction of travel of the excavator. Tilting of the attachment coupling 58 also provides the option of the working with the boom 38 (FIG. 1) of the excavator 10 in an off-center position for increased operator visibility. Other known means of providing rotation to both the swing and tilt functions include use of other linear and rotary actuators (electric, pneumatic or hydraulically powered).

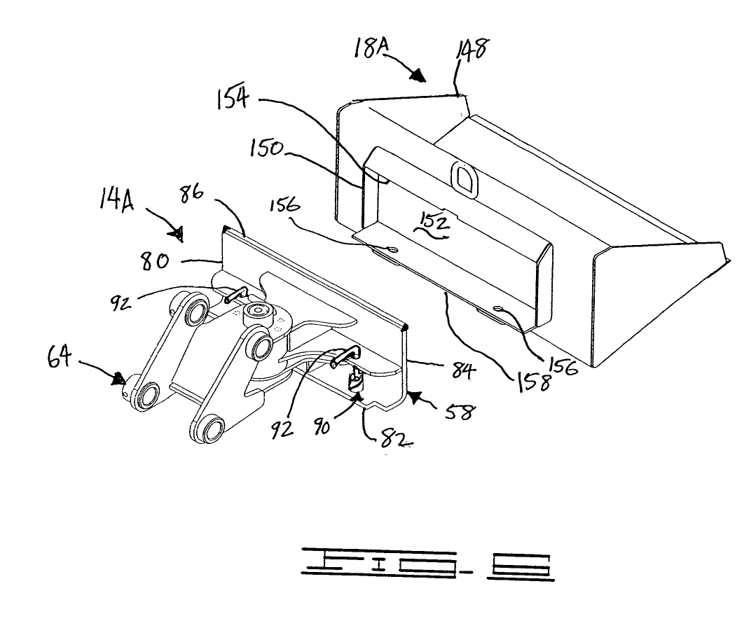

Turning now to FIG. 5 there is shown therein an alternative embodiment of the tool carrier attachment adapter of the present invention. The tool carrier attachment adapter 14C of FIG. 5 comprises an alternative mounting bracket 136 connected to the attachment coupling 58. The mounting bracket 136 of attachment adapter 14C is constructed for use with a bucket quick coupler 137. The use of mounting bracket 136 with a bucket quick coupler 137 provides increased versatility of the excavator 10 (FIG. 1) allowing rapid interchangeability between commonly used buckets and the attachment adapter 14C. Such a mounting bracket 136 comprises a first plate 138 and a second plate 140 aligned parallel to each other and adapted to matingly engage the saddle 139 of the bucket quick coupler 137 using hooks 142. When using the embodiment of FIG. 5, the bucket quick coupler 137 is operatively connected to both the dipperstick 30 (FIG. 1) and the cylinder assembly 34.

Continuing with FIG. 5, the hooks 142 each have a saddle engaging surface 144 adapted to engage the saddle of the previously described bucket quick coupler. In addition to hooks 142, the plates 138 and 140 each have an aperture 146 configured to receive a latch pin of the bucket quick coupler. Thus, when attachment adapter 14C is used in conjunction with a bucket quick coupler, the operator is able to make use of tools configured for use with the bucket quick coupler and the attachment coupling 58 because of the ability to easily attach and detach the attachment adapter and the work tools used therewith.

Turning now to FIG. 6, there is shown therein tool carrier attachment adapter 14A of the present invention with an alternative work tool 18A. For purposes of illustrating the use of attachment adapters described herein, FIG. 6 shows attachment adapter 14A and a work tool 18. The work tool 18A comprises a loader bucket 148 and a tool adapter 150. In operation, the rounded edge 86 of the first planar member 80 is inserted into an inner space 152 formed by the tool adapter 150 and under lip 154. The cylinder assembly 34 (FIG. 1) is actuated to lift the attachment adapter 14A up so that the rounded edge 86 biases the work tool 18A towards the planar face 84 of the first planar member 80.

The latch pins 92 of the latching assembly 90 are rotated inward to fasten the work tool 18A to the attachment coupling 58. As described earlier, rotating the latch pins 92 inward biases the pins through apertures formed in the second planar member 82 and corresponding apertures 156 formed in the bottom 158 of the tool adapter 150.

When the operator desires to change work tools, the latch pins 92 are rotated to unlatch attachment adapter 14, 14A, 14B, and 14C from the tool adapter 150. The attachment adapter 14, 14A, 14B or 14C is then pivoted using the cylinder assembly 34 (FIG. 1) to pivot the second planar member 82 out of the internal space 152. The attachment adapter 14, 14A, 14B or 14C is further pivoted until the tool engaging edge 86 clears the lip 154 of the tool adapter 150 and the attachment adapter can be withdrawn completely from the internal space 152.

The geometrical positioning of the pin boss mounting assembly 64 structure on the attachment adapters described herein is generally duplicative of the bucket mounting geometry. However, the angle of relation between the first planar member 80 and the pin boss mounting assembly 64 is dependent upon the geometry of the parent machine and the desired working angles of the work tools. The preferred angles of 40 to 45 degrees have been found to be universally functional.

Even though compact tool carrier attachment mounting has been described, it is envisioned attachment adapters could be made to mate with other universal attachment mounting, for example allowing use of large skid steer attachments on large size excavators or backhoes.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A work machine comprising:
a frame;
a dipperstick supported by the frame;
a cylinder assembly supported by the dipperstick; and
a tool carrier attachment adapter comprising:
a mounting bracket;
a pin boss mounting assembly supported by the mounting bracket and adapted to operatively connect the mounting bracket to both the dipperstick and the hydraulic cylinder; and
an attachment coupling comprising a planar member connected to the mounting bracket and comprising a planar face adapted to engage a work tool;
wherein the cylinder assembly is adapted to move the tool carrier attachment adapter.

2. The work machine of claim 1 wherein the cylinder assembly pivots the tool carrier attachment adapter in a vertical plane.

3. The work machine of claim 1 wherein the tool carrier attachment adapter further comprises a latching assembly adapted to fasten the work tool to the attachment coupling.

4. The work machine of claim 1 further comprising a rotation plate assembly supported by the mounting bracket and connected to the attachment coupling, wherein the rotation plate defines a pivot axis about which the attachment coupling is movable relative to the mounting bracket.

5. The work machine of claim 4 wherein the rotation plate assembly comprise a means for fixing the attachment coupling in a desired pivotal orientation relative to the mounting bracket.

6. The work machine of claim 4 wherein the tool carrier attachment adapter further comprises an actuator assembly connectable between the mounting bracket and the attachment coupling, wherein the actuator assembly is adapted to move the planar member about the pivot axis defined by the rotation plate assembly.

7. The work machine of claim 6 wherein the actuator assembly comprises a hydraulic cylinder.

8. The work machine of claim 4 wherein the pivot axis is disposed longitudinally between the pin boss mounting assembly and the attachment coupling.

9. A tool carrier attachment adapter for use with a work machine comprising a dipperstick and a cylinder assembly supported by the dipperstick, the attachment adapter comprising:
a pin boss mounting assembly;
wherein the pin boss mounting assembly operatively connects the attachment adapter to both the dipperstick and the hydraulic cylinder; and
an attachment coupling comprising a planar member connected to the pin boss mounting assembly, the planar member having a planar face adapted to engage a work tool.

10. The tool carrier attachment adapter of claim 9 wherein the planar member is pivoted in a vertical plane by actuation of the cylinder assembly.

11. The tool carrier attachment adapter of claim 9 further comprising a latching assembly adapted to the work tool.

12. The tool carrier attachment adapter of claim 9 further comprising a plurality of rotation plates supported by the pin boss mounting assembly, wherein the rotation plates define a plurality of pivot axes about which the planar member is movable relative to the pin boss mounting assembly.

13. The tool carrier attachment adapter of claim 12 further comprising a means for fixing the planar member in a desired pivotal orientation relative to the pin boss mounting assembly.

14. The tool carrier attachment adapter of claim 12 further comprising an actuator assembly connectable between the pin boss mounting assembly and the planar member and adapted to move the planar member about the pivot axis defined by the rotation plate.

15. The tool carrier attachment adapter of claim 14 wherein the actuator assembly comprises a hydraulic cylinder.

16. The tool carrier attachment adapter of claim 12 wherein at least one of the plurality of pivot axes are longitudinally disposed between the pin boss mounting assembly and the planar member.

17. The tool carrier attachment adapter of claim 9 further comprising a longitudinal pivot axis disposed between the pin boss mounting assembly and the planar member about which the planar member is pivotal relative to the pin boss mounting assembly.

18. A work machine comprising:
a frame;
a dipperstick supported on the frame;
a cylinder assembly connected to the dipperstick; and
a tool carrier attachment adapter comprising:
a pin boss mounting assembly;
wherein the pin boss mounting assembly operatively connects the attachment adapter to both the dipperstick and the hydraulic cylinder; and
an attachment coupling adapted to engage a work tool.
wherein the cylinder is adapted to move the tool carrier attachment adapter.

19. The work machine of claim 18 wherein the attachment coupling comprises a planar member having a planar face adapted to engage a work tool.

20. The work machine of claim 18 wherein the cylinder assembly pivots the attachment adapter about a first pivot axis.

21. The work machine of claim 18 comprising a latching assembly adapted to fasten the attachment coupling to a work tool.

22. The work machine of claim 18 further comprising a rotation plate supported by the mounting bracket, wherein the rotation plate defines a pivot axis about which the attachment coupling is movable relative to the mounting bracket.

23. The work machine of claim 22 wherein the pivot axis comprises a longitudinal pivot axis disposed between the pin boss mounting assembly and the attachment coupling about which the attachment coupling is pivotal relative to the pin boss mounting assembly.

24. The work machine of claim 18 further comprising a longitudinal pivot axis disposed between the pin boss mounting assembly and the attachment coupling about which the attachment coupling is pivotal relative to the pin boss mounting assembly.

25. A work machine comprising:
a frame;
a dipperstick supported on the frame;
a cylinder assembly connected to the dipperstick;
a bucket quick coupler operatively connected to both the dipperstick and the cylinder, the bucket quick coupler comprising a saddle; and
a tool carrier attachment adapter comprising:
a mounting bracket having at least one plate configured to matingly engage the saddle of the bucket quick coupler;
an attachment coupling connected to the mounting bracket and adapted to engage a work tool; and
a latching assembly supported by the mounting bracket to fasten the attachment coupling to the work tool.

26. The work machine of claim 25 wherein the attachment coupling comprises a planar member having a planar face adapted to engage the work tool.

27. The work machine of claim 25 wherein the cylinder assembly pivots the attachment coupling in a vertical plane.

28. The work machine of claim 25 further comprising a rotation plate supported by the pin boss mounting assembly, wherein the rotation plate defines a pivot axis about which the attachment coupling is movable relative to the mounting bracket.
